(19) United States
(12) Patent Application Publication
(10) Pub. No.: US 2010/0153213 A1
(43) Pub. Date: Jun. 17, 2010

(54) Systems and Methods for Dynamic Content Selection and Distribution

(76) Inventors: Kevin Pomplun, Palo Alto, CA (US); Rok Sosic, Cupertino, CA (US); Igor Benko, Sunnyvale, CA (US); Jeffrey D. Ullman, Stanford, CA (US)

Correspondence Address: CARR & FERRELL LLP, 2200 GENG ROAD, PALO ALTO, CA, 94303, US

(21) Appl. No.: 12/645,311

(22) Filed: Dec. 22, 2009

Related U.S. Application Data
(63) Continuation-in-part of application No. 12/490,283, filed on Jun. 23, 2009.
Application No. 12/490,283 is a continuation-in-part of application No. 12/319,314, filed on Jan. 5, 2009.
Application No. 12/319,314 is a continuation-in-part of application No. 12/324,596, filed on Nov. 26, 2008.
Application No. 12/324,596 is a continuation of application No. 11/843,813, filed on Aug. 23, 2007, now Pat. No. 7,464,003.
(60) Provisional application No. 60/823,478, filed on Aug. 24, 2006.

(51) Int. Cl. G06Q 30/00; G06Q 10/00

(52) U.S. Cl. 705/14.53; 705/14.54

(57) ABSTRACT

A method is provided for distributing online content to one or more delivery units. A change in content from one or more sources is detected and gathered in real time. The content is extracted from the one or more sources. The content is matched in real time to a user's interest. The delivery of the content is determined, and the content is transmitted to the one or more delivery units based on the delivery determination.

### CROSS-REFERENCE TO RELATED APPLICATIONS

This nonprovisional application is a continuation-in-part of and claims the benefit and priority of U.S. patent application Ser. No. 12/490,283 filed on Jan. 5, 2009, titled “Systems and Methods for Visualization of Real-Time Advertisement Inventory,” which is a continuation-in-part application claiming the benefit and priority of U.S. patent application Ser. No. 12/319,314 filed on Jan. 5, 2009, titled “Systems and Methods for Content Delivery,” which is a continuation-in-part application claiming the benefit and priority of U.S. patent application Ser. No. 12/324,596 filed on Nov. 26, 2008, titled “System and Method for Change Detection of Information or Type of Data,” which is a continuation application claiming the benefit and priority of U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which claims the benefit and priority of U.S. Provisional Patent Application Ser. No. 60/823,478 filed on Aug. 24, 2006, titled “Dynamic Information System,” all of which are hereby incorporated by reference. This nonprovisional application is a continuation-in-part of and claims the benefit and priority of U.S. patent application Ser. No. 12/324,596 filed on Nov. 26, 2008, titled “System and Method for Change Detection of Information or Type of Data,” which is a continuation application claiming the benefit and priority of U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which claims the benefit and priority of U.S. Provisional Patent Application Ser. No. 60/823,478 filed on Aug. 24, 2006, titled “Dynamic Information System,” all of which are hereby incorporated by reference.

### BACKGROUND

1. Field of the Invention

This invention relates generally to systems and methods for determining how any dynamic content is selected and distributed, and more particularly, to systems and methods for determining how information from the Internet is selected and distributed in dynamic environments.

2. Description of the Related Art

Since the beginning of civilization, people have made decisions based on how good or bad something is, and based on how many people are aware of information. Both of these things obviously require needing to know about something first. The creation and growth of media has been largely driven by helping people know about things, and the most successful types of media have been those that let people know about something first, or find that information fast.

When information is scarce and available, knowing about something requires little effort because a person can easily look through all the available information and find what the person is interested in. When information is abundant and available, knowing about something requires more effort because a person has difficulty looking through all the available information to find what the person is interested in. Often the person may not ever find the information.

Not finding what a person wants to know has always been something that is helpful to solve. Today this is even more important for a key reason—what people look for now are things they care about, not just things they would like to know about. As technology development has centered around the Internet for over a decade, most of the focus has been towards creating search engines that let users search through tens of if not hundreds of billions of documents to return results based on relevance. More simply said, everyone has been trying to build the best encyclopedia for the Internet.

Today things are much different. The information on the Internet is no longer things people just want to “know about.” It is information from people one personally knows, or trusts, or is interested in knowing. This is information that people “care about.” Because the value of information people “care about” is inherently more valuable than information people “know about,” it is critical that people are able to receive this information more frequently. The best system would deliver the information that people “care about” without significant delay.

There is a need for systems and methods that deliver people the information they care about without significant delay or latency. There is a further need for systems and methods that distribute content in real-time.

### SUMMARY OF THE INVENTION

An objective of the present invention is to provide systems and methods to deliver information that people care about in real-time without a significant or discernable delay or latency.

Another objective of the present invention is to provide systems and methods to distribute content in real-time.

Yet another objective of the present invention is to provide systems and methods that allow any user to specify any set of interests, at any time, from any device, to determine what content they will receive in real-time.

These and other objectives of the present invention are achieved by two types of queries. The first type is ad-hoc queries. The second type is standing queries. These types can exist independently or together.

Ad-hoc queries are for a user's interest of short duration. Said simply, user's interests are things that the user does not want to see all the time. In an exemplary embodiment, a system receives any number of user's interests greater than or equal to one, matches the user's interest to any information, and delivers the information in real-time. A practical example is a person who cares about Apple Inc.'s products and would like to know if there has been any recent information about the Apple Tablet computer. They enter “Apple Tablet” and can instantly see everything that has been said about the “Apple Tablet,” as well as continuing to see updates as they occur in real-time. The Apple Tablet is not something they want to know for an extended amount of time, but only for a limited amount of time. This example of the Apple Tablet illustrates the matching of an interest to relevant pieces of information. The interaction of a person entering “Apple Tablet” to see everything that has been said about the Apple Tablet occurs only for a limited time, and only when someone is actively interacting with the systems described herein.

Standing queries are for a user's interest of long or permanent duration. Said simply, these are user's interests that the user wishes to see all the time. A practical example is a person who cares about Apple Inc.'s products, and would like to know immediately if the new iPhone 4 G will be available in Apple retail stores. The person would like to ensure they can buy the new iPhone immediately as it is made available, and as a result it is critical they have the information immediately. Using the technology described herein, they create an alert for “iPhone 4 G release” and are notified any time there is any new information about the “iPhone 4 G release.” The user can receive the notifications in any format, time interval, device, or delivery method. The request remains active for an extended amount of time, and is always notifying the person until they ask the system no longer to provide notification.

In either the first type, ad-hoc queries, or the second type, standing queries, the user can provide preferences on who should receive the information, when, where, and how. A non-exhaustive set of examples for the category of “who” is: the person providing a preference to receive the information for just their self, a preference for others to receive the information, or a preference for others and their self. A non-exhaustive example of the category of “when” is if the user chooses to receive the information in “real-time” or any other time period selected. A non-exhaustive example of the category of “where” is the user's device, an iPhone, Blackberry, Tablet computer, or any and all other devices. A non-exhaustive example of the category of “how” is the format such as SMS, email, XML, or any and all other information formats. Another non-exhaustive example of “how” is having an option to retrieve the information from a server, such as a web server.

For one skilled in the art, below is a summary description of some exemplary systems and methods of this technology. An exemplary method may include the following five steps.

For the first step, a system continuously detects any change in any type of information. If the information has a change, the system detects the change, and gathers the changed information. The system detects the change using the following definition—change occurs when either new information is added or existing information is modified; change is the transformation, modification, alteration, variation, deviation, substitution, or any other form of difference that has occurred with the information.

An example could be Robert Scoble's published update to his Twitter page (http://twitter.com/scobleizer) announcing that he is happy about the Apple Tablet computer. This new update is an example of information with a change. The technology would detect this change, and then gather the changed information. An important distinction and novel creation of this technology is gathering all changes from all information, and not just a single site (in the example above, Twitter is one of millions of sites for which changes are detected). Prior systems to date have gathered changes from one to a few sites, but no system has gathered changes from millions of sites, resulting in trillions of changes (millions of changes on millions of sites).

For the second step, the technology described herein extracts the information and may assign zero or more tags to the information. In this example, the system would extract the new update that was published and assigns one or more tags to classify the information. To do this tagging, the system analyzes the information and assigns tags to classify the information. Tags can be simple (such as an author's name or the time the author updated his page) or tags can be complex (such as the subject of the information and what the author is happy about).

For the third step, the system sends the information to a “matching unit.” The matching unit is a streaming pipeline containing any potential thing a user could want to match the information to. The elements in the matching unit could be as specific as “things Robert Scoble is happy about from Apple,” or as broad as “news.” All items in the matching unit are matched in real-time with the user interests that are stored in the user interest database. The user interest database holds each user's interests that the user would like to have matched. These interests from the user interest database are used by the matching unit to identify matches between the real-time information and the interests. The content and the tags of the real-time information, as mentioned in step two above, are used to help identify what things match a user's interests.

The real-time matching is an important distinction and one of the many novel features of the technology and systems described herein. Prior systems to date have been database-driven, and do not gather or deliver the matching information in real-time. To be clear, prior systems would store things in a database, and then every few minutes or hours (or longer), check the database to see if the database contained anything matching the user's interests. This technology, by contrast, is continuously always gathering and matching things in real-time.

At the fourth step, the decision for delivery is made. The decision for delivery is simple, and can be one of two results. Result one is that no match to a user's interest has been found. In that case, the system simply stores the change in a database to archive the information. Result two is a match to one or more users' interests. In that case, the system passes the information immediately to a delivery unit. In the example above for the second method if a new change is detected about the “iPhone 4 G release” it may match the user's interest and be delivered immediately to a delivery unit.

The fifth step provides for how the information reaches the delivery unit. The system receives the user's preferences (as mentioned above in the first and second steps), and then delivers the matched information (i.e. “things Robert Scoble is happy about from Apple”) as specified by the user's preferences.

Additionally, below is a summary description of one exemplary algorithm for the second type of queries described above—standing queries—and how those standing queries are used in methods of this technology. The algorithm may be performed by any hardware platform suitable for performing the processing described herein, including but not limited to computer-readable storage media. According to various embodiments of the present invention, the technology matches standing queries in the form of a set of words against content (such as online content in the form of one or more documents). The words may be keywords.

In some exemplary embodiments, a standing query may be defined as a set of words. Queries may be stored as lists of words, sorted by an ordering. According to some embodiments of the present technology, the ordering by which queries are stored as lists of words is the same ordering used to process the words of a document.

According to various embodiments of the present technology, standing queries have their words ordered according to some ordering. In some embodiments, ordering of the words may be lexicographic. In some embodiments, ordering of the words may be such that the rarest word is listed first in a list of words. That is, words in a document may be ordered such that the rarest word found in the document (in terms of frequency) is listed first in the ordering, and the ordering continues until the most frequently found word in the document is provided last.

A standing query may be represented by an object (i, w₁, w₂, . . . , wₙ), where count i is the number of words matched, and the w's may be the words of the standing query in order. The system may put a limit on the number of words, e.g., 10, for ease in representation, but can function with any number of words. Initially, the count is 0, meaning that no words have been matched by the current document to be matched.

Each query object may be stored in an inverted index, indexed by its first word. In some embodiments, the count associated with these stored objects will always be 0.

To process a document as described in the third step of the exemplary method set forth above, the system may use a hash table with many buckets. The hash table may be stored in any type of memory associated with the system, including, but not limited to, main memory.

As each document is processed, this hash table will contain certain query objects (i, w₁, w₂, . . . , wₙ), meaning that the first i words of the query are successfully matched for this document. An important aspect of the invention is that the hash key for such an object will be wᵢ₊₁. When the system processes a new document, the algorithm may execute as follows:

The words of the document are ordered according to the chosen order.

The system initializes the hash table to empty.

Then, for each word w in the ordered list of words in the document, the following steps are executed: 1) The system goes to the hash table and finds objects hashed with key w. These standing queries have had an additional word matched by the document. Each standing query has its count incremented by 1 (one), and are these standing queries are rehashed according to the next word on their lists. However, if there is no next word, then the standing query has been completely matched by the document, and it goes to the list of queries matched by this document. 2) Then, the system goes to the inverted index and finds all query objects with w as their first word. 3) Next, the system adds each of these objects to the hash table with a count of 1 (one). Note that according to the system's policy for hash keys, the second word of the query is the hash key. However, if the query does not have a second word (i.e., it is a single-word query), then this query has been successfully matched. This query is removed from the hash table and goes to the output of queries matched by this document.

An important note is that the work per document is the sum of all queries of the number of words in its prefix that get matched by the document.

### BRIEF DESCRIPTION OF THE DRAWINGS

FIG. 1 is a flow chart showing an exemplary method for providing dynamic content in real-time.

FIG. 2 is a diagram of an exemplary architecture of a system for performing one or more methods described herein.

FIG. 3 is an exemplary screenshot of a display on a network-enabled device that is interacting with the system shown in FIG. 2.

### DETAILED DESCRIPTION OF THE INVENTION

Systems and computerized methods for delivering information in real-time are provided herein. This technology allows for the delivery and distribution of information or data content in real-time. Specifically, the technology identifies and provides information that users care about in real-time. Further, the technology permits for users to provide or input any set of interests at any time using any device, in order to indicate to the system what type of content they wish to receive in real-time.

According to some exemplary embodiments, the technology determines when information on the Internet has changed. When information or data on the Internet has changed, such information may be gathered. If the changed information matches a user's interests, then the system determines that the information should be delivered and transmits the information to the user's device or delivery unit, based on the user's preferences. One skilled in the art may recognize that a user's preferences may be stored in a user profile on a web server associated with the technology, or the user's preferences may be provided on-the-fly utilizing one or more network-enabled devices. According to some embodiments, the system continuously identifies in real-time information as having been changed. Such changed information obtained may come from any number and type of sources (including but not limited to one or more websites, social networks, online publications, data streams, data sources, news feeds, RSS feeds, blog entries, and the like). The changed information may be obtained from any number of multiple sources, such as a plurality of websites on the Internet or sources on a network. The sources may come from third party resources and platforms. This technology may be compatible with several types of sources, regardless of source platform. In accordance with some exemplary embodiments, once the changed information is obtained, the changed information is processed so that the content is obtained or extracted. Furthermore, using this technology, a user may obtain in real time information which matches or otherwise relates to the user's interests.

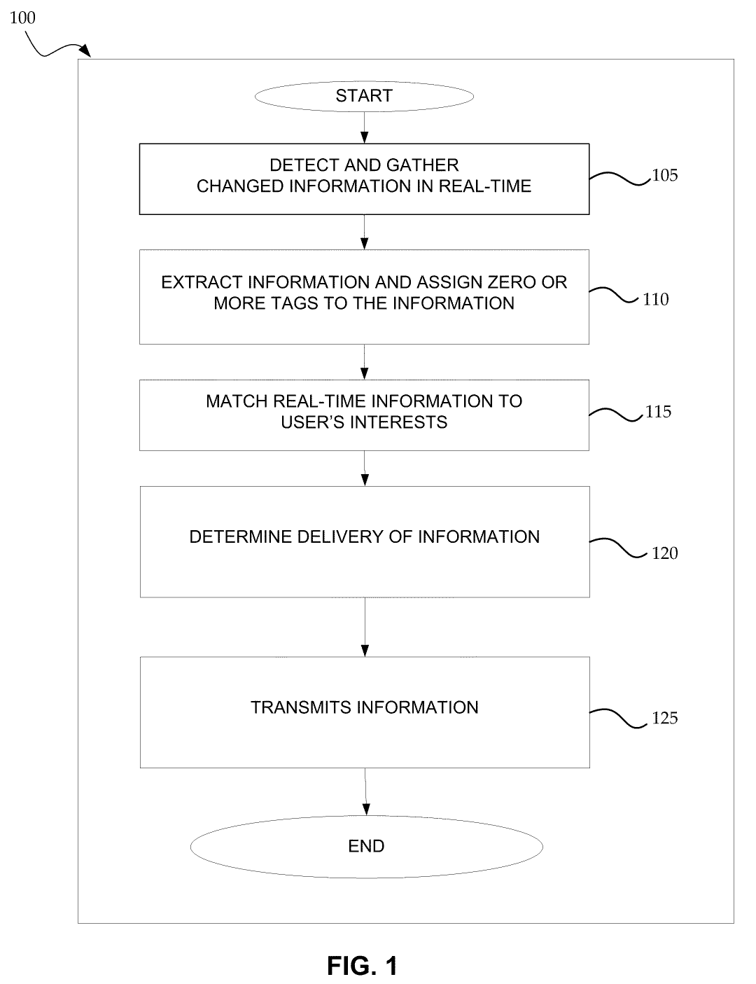

The technology may employ any type of methodology for selecting dynamic content and distributing the same to user in real-time. FIG. 1 is a flowchart illustrating an exemplary method 100 for providing dynamic content in real-time. In step 105, a system detects and gathers changed information in real-time. According to some exemplary embodiments, the system detects any change in any type of information continuously. Change occurs when either new information is added or existing information is modified. Change is the transformation, modification, alteration, variation, deviation, substitution, or any other form of difference that has occurred with the information. According to various embodiments, the system detects change in documents and other data information sources that are accessible over a network.

Content may include text, audio, a link, an image, a radio broadcast, a podcast, video, a blog entry, an advertisement, a news wire, a mainstream media item, a data stream, data from a social networking website, any type of information that relates to a query, any type of information from a source, or any combination thereof. The changed information may be of any content type and include one or more changes in any type of content, including but not limited to, words, symbols, characters, letters, pictures, figures, placement of content, and any combination thereof.

Exemplary methods of detection for change in information or type of data are provided in U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which is incorporated by reference in its entirety.

Detecting in real time a change in information may include detecting such changed information within a predefined velocity value. Such a predefined velocity value may be measured as a point closest in time to when the information was changed, edited, or otherwise modified relative to when the information was gathered, identified, received, reviewed, analyzed, or otherwise processed by the technology. Hence, detecting an information change in real time may include determining a time difference between the occurrence of an information change and the detection of the information change by the present system, wherein the time difference is less than the predefined velocity value (e.g., below a threshold value for the velocity value). The predefined velocity value (velocity value threshold) may be set such that there is no discernable delay or latency between the actual change and the detection of the change to a user of the present system.

At step 110, the technology extracts the information and assigns zero or more tags to the information. The technology analyzes the information and assigns tags to classify the tagging. The tagging may be provided to the extracted information such that the extracted information may be categorized, prioritized, filtered, categorized, or otherwise identified to provide a quick response time to a query. Tagging may include applying unique identifiers generated by the technology to the information. The tags themselves may provide information about the extracted information itself, the source of the extracted information, the changes to the extracted information, the name of the person(s) who authored the information, a timestamp as to when the information was extracted, the date and time that a change occurred to the information, the date and time that an update to the information occurred, the subject of the information, or any combination thereof.

The analysis to determine tagging of information may include evaluating the extracted information. Any number and types of evaluation techniques and methods may be utilized. For instance, evaluation methods using clusters, reputation, sentiment, duplicate detection and the like are provided in U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which is incorporated by reference in its entirety. According to various embodiments of the technology, the extracted information may be tagged based on the evaluation conducted by the system.

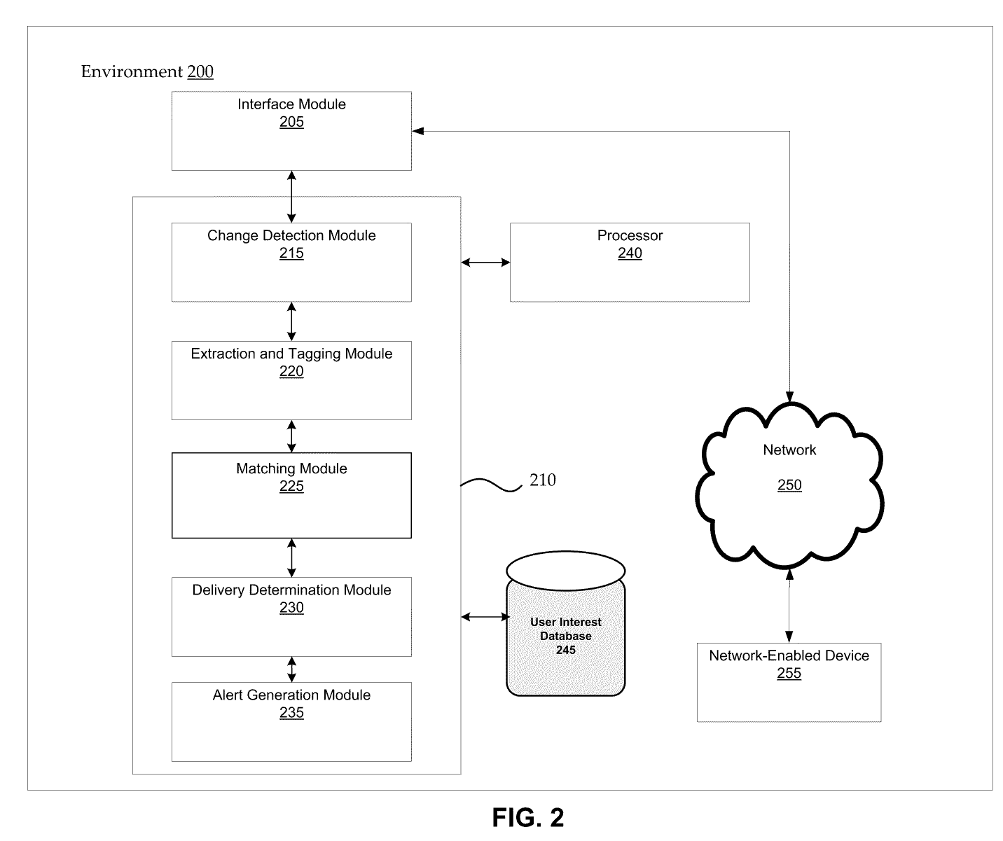

Referring still to FIG. 1, at step 115, the extracted information is transmitted to a matching unit of the system, where information may be matched in real-time to a user's interests. The matching unit may include or be coupled to one or more processors of a computerized device. The matching unit matches in real-time information in the matching unit with user interests of one or more users. User interests may be stored in a user interest database (such as an exemplary user interest database 245 in FIG. 2) or any other type of database or memory storage. The content and tags of the real-time information, as described earlier herein for step 110, are utilized to help determine what real-time information matches a user's interests at step 115. In other words, matching by the systems provided herein occurs in real-time. The systems utilizing this technology are continuously gathering and matching information with one or more user's interests, all in real time.

In a non-exhaustive list, user interests may include a name of a person, a name of an event, a name of a publication, a topic, one or more keywords, a key phrase, a slogan, a company name, a stock ticker, a sector name, an industry name, a group name, a product name or any combination thereof. Such user interests may be submitted, entered, transmitted, or otherwise provided via any types and/or number of devices. In a non-exhaustive list, the types of devices by which a user interest may be provided to the system include a laptop computer, a desktop computer, a smartphone, a personal digital assistant (PDA), a portable handheld device, a gaming device, a computing device, a mobile communications device, or any combination thereof. The user interest may be received via a network, such as a network 250 as shown in FIG. 2. A network may be a local, proprietary network (e.g., intranet) and/or may be a part of a larger wide-area network. For example, the network may be a local area network (LAN), which may also be communicatively coupled to a wide area network (WAN) such as the Internet. A network allows for communication between the various components of a system, such as the system shown in FIG. 2.

User interests may be saved for continuous queries or searches. A query may be set based on one or more search criterion received via a user input from a network-enabled device. A network-enabled device may be a laptop computer, a desktop computer, a smartphone, a personal digital assistant (PDA), a portable handheld device, a gaming device, a computing device, a mobile communications device, or any combination thereof. The query may then be saved in a database (such as a user interest database 245) or on a memory storage of the system or on the network-enabled device 255 (FIG. 2). Such a saved query may be run multiple times on the network. Alternatively, the query may be executed periodically or continuously on the network such that the network may be “scraped” for relevant search results in real time. Alternatively, the query may be done on-the-fly following a user entering a search query string through an interface of the web server associated with this technology.

According to various embodiments of the present technology, the step 115 may include one or more additional steps, which are provided later herein. According to various embodiments of the present invention, the technology matches standing queries in the form of a set of words against content (such as online content in the form of one or more documents). The words may be keywords.

In some exemplary embodiments, a standing query may be defined as a set of words. Queries may be stored as lists of words, sorted by an ordering. According to some embodiments of the present technology, the ordering by which queries are stored as lists of words is the same ordering used to process the words of a document.

According to various embodiments of the present technology, standing queries have their words ordered according to some ordering. In some embodiments, ordering of the words may be lexicographic. In some embodiments, ordering of the words may be such that the rarest word is listed first in a list of words. That is, words in a document may be ordered such that the rarest word found in the document (in terms of frequency) is listed first in the ordering, and the ordering continues until the most frequently found word in the document is provided last.

A standing query may be represented by an object (i, w₁, w₂, . . . , wₙ), where count i is the number of words matched, and the w's may be the words of the standing query in order. The system may put a limit on the number of words, e.g., 10, for ease in representation, but can function with any number of words. Initially, the count is 0, meaning that no words have been matched by the current document to be matched.

Each query object may be stored in an inverted index, indexed by its first word. In some embodiments, the count associated with these stored objects will always be 0.

To process a document as described in the third step of the exemplary method set forth above, the system may use a hash table with many buckets. The hash table may be stored in any type of memory associated with the system, including, but not limited to, main memory.

As each document is processed, this hash table will contain certain query objects (i, w₁, w₂, . . . , wₙ), meaning that the first i words of the query are successfully matched for this document. An important aspect of the invention is that the hash key for such an object will be wᵢ₊₁. When the system processes a new document, the algorithm may execute as follows:

The words of the document are ordered according to the chosen order.

The system initializes the hash table to empty.

Then, for each word w in the ordered list of words in the document, the following steps are executed: 1) The system goes to the hash table and finds objects hashed with key w. These standing queries have had an additional word matched by the document. Each standing query has its count incremented by 1 (one), and are these standing queries are rehashed according to the next word on their lists. However, if there is no next word, then the standing query has been completely matched by the document, and it goes to the list of queries matched by this document. 2) Then, the system goes to the inverted index and finds all query objects with was their first word. 3) Next, the system adds each of these objects to the hash table with a count of 1 (one). Note that according to the system's policy for hash keys, the second word of the query is the hash key. However, if the query does not have a second word (i.e., it is a single-word query), then this query has been successfully matched. This query is removed from the hash table and goes to the output of queries matched by this document.

An important note is that the work per document is the sum of all queries of the number of words in its prefix that get matched by the document.

Referring to FIG. 1, at step 120, a decision for delivery of the matched information is determined. According to some embodiments, one of two results occurs. If there is no match to a user's interests, based on the evaluation conducted by the matching unit as described in step 115, then the system stores the changed information into an archival database, in order to archive such information. On the other hand, if the matching unit determines in step 115 that information matches one or more users' interests, then the information is transmitted immediately to one or more delivery units of the users. According to various embodiments, the method 100 may also include receiving the user's interest from one or more network-enabled devices (not shown) and storing the user's interest in a user interest database (such as the user interest database 245 in FIG. 2).

At step 125, the information is transmitted to one or more delivery units. The system is configured to receive a user's preferences at any time, and then deliver matched information as specified by the user's preferences. The user's preferences may indicate that the user wishes to receive the matched information to a delivery unit, such as a network-enabled device. As mentioned earlier, a network-enabled device may be a laptop computer, a desktop computer, a smartphone, a personal digital assistant (PDA), a portable handheld device, a gaming device, a computing device, a mobile communications device, or any combination thereof.

Furthermore, if matched information is identified, then an alert may be generated of the content (not shown). Such an alert may be generated at steps 115, 120 and/or 125 of the method 100. The alert may be configured to be transmitted for display in real time to the user's network-enabled device. In some embodiments, this step further includes transmitting within a predefined velocity value (e.g., within a predefined time period) an alert of the matched information to a network-enabled device. According to various embodiments, the predefined velocity value is measured as a point closest in time to when the alert was generated, edited, or modified relative to when the matched information was determined. Another optional step is generating a description that describes the matched information. The generated description may be included as part of the alert of the matched information that is sent to the network-enabled device.

It will be appreciated by one skilled in the art that not all of the steps presented in FIG. 1 are necessary for various embodiments of this technology to work. Some steps may be skipped, merged, deleted, repeated, switched around, and/or altered, without departing from the spirit and the scope of various exemplary embodiments of the technology. FIG. 1 is exemplary only, as are all the figures provided herewith.

FIG. 2 is a diagram of an exemplary computing environment 200 in which an exemplary system may distribute content in real-time. It will be appreciated by one skilled in the art that not all of the components presented in FIG. 2 are necessary for various embodiments of this technology to work. Some components may be deleted, combined and/or altered, without departing from the spirit and the scope of various exemplary embodiments of the technology. Similarly, other elements not illustrated, such as memory, may be used with the illustrated components illustrated within FIG. 2.

The exemplary environment 200 comprises an interface module 205, an exemplary real-time delivery server 210 having a plurality of modules 215-235, a processor 240, a user interest database 245, a network 250, and one or more network-enabled devices 255.

Still referring to FIG. 2, the real-time delivery server 210 may include a memory (not shown). The memory may include any device configured to store data, including a computer readable storage medium. Some examples of memory include storage devices, such as RAM or ROM. In various exemplary embodiments, the real-time delivery server 120 may include a change detection module 215, an extraction and tagging module 220, a matching module 225, a delivery determination module 230, and an alert generation module 235. However, one skilled in the art may recognize that any module(s) that perform the steps of the method 100 (FIG. 1) may suffice.

The real-time delivery server 210 may be coupled to or may include a processor 240 for executing various instructions and modules stored in memory. The processor 240 is configured to execute executable instructions. In some embodiments, the processor 240 comprises circuitry or any processor capable of processing the executable instructions.

A module (or application) should be generally understood as a collection of routines that perform various system-level functions and may be dynamically loaded and unloaded by hardware and device drivers as required. The modular software components described herein may also be incorporated as part of a larger software platform or integrated as part of an application specific component.

The real-time delivery server 210 may communicate with one or more network-enabled devices 255 over the network 250. The network-enabled devices 255 may require real-time delivery of changed information, and thus may request and obtain such services via their interaction with the real-time delivery server 210. Such network-enabled devices 255 may provide user interests and/or queries, and the real-time delivery server 210 may determine information that is relevant to or matches a given user interest or query. The real-time delivery server 210 may provide notifications or alerts of matched information to the network-enabled device 255.

According to some exemplary embodiments, the interface module 205 is configured to receive user input (such as user's interests, user's preferences, a user's query, and any combination thereof) via the network 250. The network 250 has been previously discussed. Briefly, the network 250 allows for communication between the various components of the system 200. The user's query or interest may be received from a network-enabled device 255, such as an exemplary user digital device (not shown). The query may be manually entered by a user of the network-enabled device 255, or the query may be automatically generated and sent by the network-enabled device 255. For example, the network-enabled device 255 may be programmed to automatically send a query, such as a location identifier of the network-enabled device 255. An example of this is where the network-enabled device 255 is a smartphone by which the cellphone user's location may be determined. The smartphone may be programmed to elicit information of the newest restaurants within a certain proximity to the cellphone user's current location.

A change detection module 215, in some exemplary embodiments, is in communication with the interface module 205. For example, the interface module 205 may communicate a received change in information to the change detection module 215. In other words, the change detection module 215 may identify and receive changes in information from sources, such as web pages. The change detection module 215 is executable by the processor 240 to process changes in information. For instance, the change detection module 215 may identify that updates have occurred on a plurality of web pages. According to various embodiments, the change detection module 215 may accomplish the step 105 of the method 100 in FIG. 1. As mentioned previously, exemplary methods of detection for change in information or type of data are provided in U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which is incorporated by reference in its entirety. Such methods for detection may be utilized by the change detection module 215.

Still referring to FIG. 2, an extraction and tagging module 220, in some embodiments, is in communication with the change detection module 215. The extraction and tagging module 220 is configured to extract or otherwise obtain information. Also, the extraction and tagging module 220 may assign zero or more tags to the information. In some exemplary embodiments, the extracted information may be tagged based on an evaluation conducted by the extraction and tagging module 220. Some exemplary evaluation methods (such as clusters, reputation, sentiment, duplicate detection and the like) are provided in U.S. patent application Ser. No. 11/843,813 filed on Aug. 23, 2007, titled “System and Method for Change Detection of Information or Type of Data,” now U.S. Pat. No. 7,464,003 as issued on Dec. 9, 2008, which is incorporated by reference in its entirety.

According to various embodiments, the extraction and tagging module 220 may accomplish step 110 of the method 100 in FIG. 1. However, one skilled in the art will recognize that any of the steps in FIG. 1 may be accomplished by the processor 240 and/or any portion of the server 210, including one or more of the plurality of modules stored on the server 210.

Still referring to FIG. 2, the delivery determination module 220 determines how delivery of the information is made. If no match was made of the information to one or more users' interests, then the changed information is stored in a database (not shown) coupled to the system, in order to archive the information. If a match was made, thereby matching the information to one or more users' interests, then the information is transmitted to a delivery unit. According to various embodiments of the technology, the real-time delivery server 210 may receive a user's preferences for delivery and deliver the matched information to the user's network-enabled device 255 by the specifications set forth in the user's preferences. According to some exemplary embodiments, the delivery determination module 220 may accomplish either or both of the steps 120 and 125 of the method 100 (FIG. 1).

The optional alert generation module 235 is configured to provide an alert configured for transmission via the interface module 205 to the network 250 and ultimately to the network-enabled device 255. The alert generation module 235 may provide an alert in any format. In a non-exhaustive list, a generated alert may include any type of content as described herein, including but not limited to text, audio, video, link(s), image(s), an audio clip, a visual clip, and any combination thereof. The generated alert may include a description of the information being provided to the user, as described in greater detail earlier herein. Further, the generated alert may be delivered in any format, such as in an email, a SMS, a MMS, a ringtone, XML, a website link, a data stream, a pop-up window, an entry on a website, an entry on a newsfeed (such as a RSS feed), or any combination thereof, and the like. The generated alert may be delivered to the network-enabled device using one or more computer applications, such as Microsoft Outlook, Word, and the like. For instance, the generated alert may appear in a person's Outlook inbox on his or her personal computer.

Still referring to FIG. 2, the environment 200 may further include a user interests database 245, which may be coupled with the real-time delivery server 210 (as shown in FIG. 2) or may be provided elsewhere in the environment 200. The user interests database 245 may be configured to store any type of user interests provided by one or more users, as described herein. Further databases may be allowed, in order to store or archive information that has not yet been matched to one or more users' interests. The network-enabled devices 255 may comprise any combination of computer hardware and software configured to receive and transmit information over network 250, thereby communicating with the real-time delivery server 210, a web server (not shown) coupled to the real-time delivery server 210 and provides a newsfeed of changed information, and/or the user interests database 245.

The systems, methods and media discussed herein may be utilized in conjunction with any type of computer platform, application and/or server. Exemplary platforms that may be used in conjunction with the technology discussed herein are described in U.S. patent application Ser. No. 12/490,283 filed on Jan. 5, 2009, titled “Systems and Methods for Visualization of Real-Time Advertisement Inventory,” U.S. patent application Ser. No. 12/319,314 filed on Jan. 5, 2009, titled “Systems and Methods for Content Delivery,” U.S. patent application Ser. No. 12/324,596 filed on Nov. 26, 2008, titled “System and Method for Change Detection of Information or Type of Data,” and U.S. patent application Ser. No. 11/843,813 filed on Aug. 23, 2007, titled “System and Method for Change Detection of Information or Type of Data,” all of which are incorporated by reference herein in their entirety.

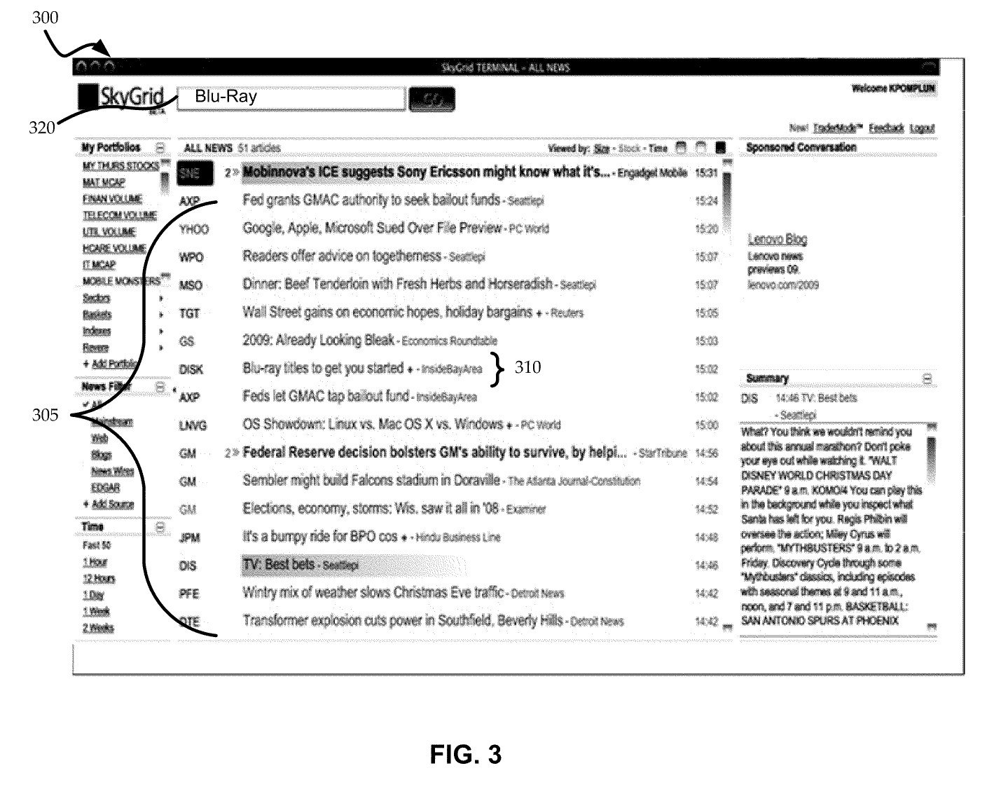

According to various embodiments, an optional generated alert regarding information matching a user's interest or query is provided to the user as an entry on a website which is displayed to the user in real-time. An exemplary screenshot 300 of an exemplary website is provided in FIG. 3. Such an exemplary website may be hosted by the real-time delivery server 210 (FIG. 2) or may be otherwise associated with the real-time delivery server 210 (FIG. 2) through the network 250 (FIG. 2). The exemplary screenshot 300 may be displayed on a browser of the user's network-enabled device. According to some embodiments, the alert is provided as part of a real-time newsfeed shown on the browser. In an entry 310, the first web site is “Twitter” which is associated with an entry that begins with “I started using my iPhone.” As described more fully in U.S. patent application Ser. No. 12/319,314 filed on Jan. 5, 2009, titled “Systems and Methods for Content Delivery,” the exemplary screenshot 300 of the web site may include stock tickers, such as APPL as shown in the entry 310. Furthermore, the exemplary screenshot 300 shows “ALL NEWS” which can be found below the query box 320. If the user selected or typed in “Information Technology,” the web site would then show all the news feed of the companies associated with the Information Technology sector, but it would not show the news feed of companies that are not associated with the Information Technology. For instance, in “ALL NEWS,” the stock ticker “GM” for “General Motors” is shown for two stories entitled “Sembler might build Falcons stadium in Doraville” and “Elections, economy, storms: Wis. saw it all in '08.” However, if the user selected the “Information Technology” sector, then “Information Technology” would replace the “ALL NEWS” designation, and the stories related to the ticker “GM” would no longer appear since General Motors is not a company associated with the Information Technology sector.

The screenshot 300 also shows how the technology may provide the user with the knowledge of where changed content relating to the stored user's interest or query is located on the Internet. If matches are found, matching gathered changed information or content with a stored user's interest or query, then such matches are shown as a news feed entry on a list (such as the list 305). Furthermore, if the user wants to determine in real-time where all mentions of iPhones are located on the Internet, the user may type in “iPhone” in the query box 320 and the technology will deliver in real-time a list (such as the list 305) as news feed entries of all changed content on the Internet that discuss iPhone. This would include entries of all websites, blogs, search engines, and the like, including such social networks as Twitter. In other words, in some embodiments, this technology allows for a delivery in real time of all data existing on the Internet without being limited to searching on a particular website, such as Twitter.

Some of the above-described functions may be composed of instructions that are stored on storage media (e.g., computer-readable medium). The instructions may be retrieved and executed by the processor 240. Some examples of storage media are memory devices, tapes, disks, and the like. The instructions are operational when executed by the processor 240 to direct the processor 240 to operate in accord with the invention. Those skilled in the art are familiar with instructions, processor(s), and storage media.

It is noteworthy that any hardware platform suitable for performing the processing described herein is suitable for use with the invention. The terms “computer-readable storage medium” and “computer-readable storage media” as used herein refer to any medium or media that participate in providing instructions to a CPU for execution. Such media can take many forms, including, but not limited to, non-volatile media, volatile media and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one embodiment of a bus. Transmission media can also take the form of acoustic or light waves, such as those generated during radio frequency (RF) and infrared (IR) data communications. Common forms of computer-readable media include, for example, a floppy disk, a flexible disk, a hard disk, magnetic tape, any other magnetic medium, a CD-ROM disk, digital video disk (DVD), any other optical medium, punch cards, paper tape, any other physical medium with patterns of marks or holes, a RAM, a PROM, an EPROM, an EEPROM, a FLASHEPROM, any other memory chip or cartridge, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

The above description is illustrative and not restrictive. Many variations of the invention will become apparent to those of skill in the art upon review of this disclosure. The scope of the invention should, therefore, be determined not with reference to the above description, but instead should be determined with reference to the appended claims along with their full scope of equivalents.

While the present invention has been described in connection with a series of preferred embodiment, these descriptions are not intended to limit the scope of the invention to the particular forms set forth herein. It will be further understood that the methods of the invention are not necessarily limited to the discrete steps or the order of the steps described. To the contrary, the present descriptions are intended to cover such alternatives, modifications, and equivalents as may be included within the spirit and scope of the invention as defined by the appended claims and otherwise appreciated by one of ordinary skill in the art.

What is claimed is:

1. A method for distributing content via a computing device having instructions stored in memory, the method comprising:
executing instructions stored in memory to detect and gather in real-time
a change in the content from one or more sources;
executing instructions stored in memory to extract the content from the one or more sources;
executing instructions stored in memory to match in real time the content to a user's interest;
executing instructions stored in memory to determine delivery of the content; and
executing instructions stored in memory to transmit the content to a delivery unit based on the delivery determination.

2. The method of claim 1, wherein detecting in real-time a change in content further comprises detecting the content change within a predefined velocity value threshold.

3. The method of claim 2, wherein the predefined velocity value is measured as a point closest in time to when the content was changed, edited, or otherwise modified relative to when the content was last gathered.

4. The method of claim 1, wherein the content comprises text, audio, a link, an image, a radio broadcast, a podcast, video, a blog entry, an advertisement, a news wire, a mainstream media item, a data stream, data from a social networking website, any type of information that relates to a query, any type of information from a source, or any combination thereof.

5. The method of claim 1, wherein the method further comprises:
receiving the user's interest; and
storing the user's interest in a user interest database.

6. The method of claim 5, wherein the user's interest includes a name of a person, a name of an event, a name of a publication, a topic, one or more keywords, a key phrase, a slogan, a company name, a stock ticker, a sector name, an industry name, a group name, a product name or any combination thereof.

7. The method of claim 1, further comprising tagging one or more tags to the content.

8. The method of claim 7, wherein the step of matching in real time the content to a user's interest further comprises analyzing the one or more tags associated with the content.

9. The method of claim 1, wherein the content comprises a document and the user's interest comprises a query having one or more query words.

10. The method of claim 9, wherein the step of matching in real time the content to a user's interest further comprises matching in real time a plurality of words in the document against the one or more query words of the query.

11. The method of claim 9, wherein the step of matching in real time the content to a user's interest further comprises:
ordering the one or more query words of the query, resulting in a query word list;
ordering the plurality of words of the document, resulting in a list of ordered words;
initializing a hash table stored in memory to empty; and
processing each word in the list of ordered words by utilizing the hash table and an inverted index, the inverted index being stored in memory.

12. The method of claim 11, wherein the query is represented by an object (i, w₁, w₂, . . . , wₙ), where i represents a number of words matched and w₁, w₂, . . . , wₙ represent the one or more query words in order and further wherein processing each word in the list of ordered words further comprises:
locating in the hash table the one or more query objects hashed with a key w;
adding one to each count of the one or more query objects;
if there is a next word on the list of ordered words, rehashing the one or more query objects according to the next word; and
if there is no next word on the list of ordered words, adding the one or more query words to a query output list matched to the document.

13. The method of claim 1, wherein the step of determining delivery of the content further comprises:
determining whether a match was found during the matching step;
if the match was found, transmitting the content to a network-enabled device; and
if no match was found, transmitting the content to an archival database.

14. The method of claim 13, wherein the network-enabled device comprises a laptop computer, a desktop computer, a smartphone, a personal digital assistant (PDA), a portable handheld device, a gaming device, a computing device, a mobile communications device, or any combination thereof.

15. The method of claim 13, wherein transmitting the content to a network-enabled device is based on a user's preferences.

16. The method of claim 1, wherein the method further comprises:
generating an alert of the content; and
transmitting for display the alert of the content to a network-enabled device in real time.

17. The method of claim 16, wherein the generated alert comprises an email, a SMS, a MMS, a ringtone, a website link, a data stream, a pop-up window, an entry on a website, an entry on a newsfeed or any combination thereof.

18. A computer readable storage medium having embodied thereon a program, the program being executable a processor to perform a method for distributing content, the method comprising:
detecting and gathering in real-time a change in the content from one or more sources;
extracting the content from the one or more sources;
matching in real time the content to a user's interest;
determining delivery of the content; and
transmitting the content to a delivery unit based on the delivery determination.

19. The computer readable storage medium of claim 18, wherein detecting in real-time a change in content further comprises detecting such changed content within a predefined velocity value.

20. The computer readable storage medium of claim 19, wherein the predefined velocity value is measured as a point closest in time to when the content was changed, edited, or otherwise modified relative to when the content was last gathered.

21. The computer readable storage medium of claim 18, wherein the content comprises text, audio, a link, an image, a radio broadcast, a podcast, video, a blog entry, an advertisement, a news wire, a mainstream media item, a data stream, data from a social networking website, any type of information that relates to a query, any type of information from a source, or any combination thereof.

22. The computer readable storage medium of claim 18, wherein the method further comprises:
receiving the user's interest; and
storing the user's interest in a user interest database.

23. The computer readable storage medium of claim 18, wherein the user's interest includes a name of a person, a name of an event, a name of a publication, a topic, one or more keywords, a key phrase, a slogan, a company name, a stock ticker, a sector name, an industry name, a group name, a product name or any combination thereof.

24. The computer readable storage medium of claim 18, wherein the method further comprising tagging one or more tags to the content.

25. The computer readable storage medium of claim 24, wherein the step of matching in real time the content to a user's interest further comprises analyzing the one or more tags associated with the content.

26. The computer readable storage medium of claim 18, wherein the content comprises a document and the user's interest comprises a query having one or more query words.

27. The computer readable storage medium of claim 26, wherein the step of matching in real time the content to a user's interest further comprises matching in real time a plurality of words in the document against the one or more query words of the query.

28. The computer readable storage medium of claim 26, wherein the step of matching in real time the content to a user's interest further comprises:
ordering the one or more query words of the query, resulting in a query word list;
ordering the plurality of words of the document, resulting in a list of ordered words;
initializing a hash table stored in memory to empty; and
processing each word in the list of ordered words by utilizing the hash table and an inverted index, the inverted index being stored in memory.

29. The computer readable storage medium of claim 28, wherein the query is represented by an object (i, w₁, w₂, . . . , wₙ), where i represents a number of words matched and w₁, w₂, . . . , wₙ represent the one or more query words in order and further wherein processing each word in the list of ordered words further comprises:
locating in the hash table the one or more query objects hashed with a key w;
adding one to each count of the one or more query objects;
if there is a next word on the list of ordered words, rehashing the one or more query objects according to the next word; and
if there is no next word on the list of ordered words, adding the one or more query words to a query output list matched to the document.

30. The computer readable storage medium of claim 18, wherein the step of determining delivery of the content further comprises:
determining whether a match was found during the matching step;
if the match was found, transmitting the content to a network-enabled device; and
if no match was found, transmitting the content to an archival database.

31. The computer readable storage medium of claim 30, wherein the network-enabled device comprises a laptop computer, a desktop computer, a smartphone, a personal digital assistant (PDA), a portable handheld device, a gaming device, a computing device, a mobile communications device, or any combination thereof.

32. The computer readable storage medium of claim 30, wherein transmitting the content to a network-enabled device is based on a user's preferences.

33. The computer readable storage medium of claim 18, wherein the method further comprises:
generating an alert of the content; and
transmitting for display the alert of the content to a network-enabled device in real time.

34. The computer readable storage medium of claim 33, wherein the generated alert comprises an email, a SMS, a MMS, a ringtone, a website link, a data stream, a pop-up window, an entry on a website, an entry on a newsfeed or any combination thereof.

35. A system for real-time distribution of content, the system comprising:
a memory configured to store content;
a processor configured to execute instructions stored in memory to:
detect and gather in real-time a change in the content from one or more sources;
extract the content from the one or more sources;
match in real time the content to a user's interest; and
determine delivery of the content; and
an interface configured to transmit the content to a delivery unit based on the delivery determination.

36. The system of claim 35, wherein the instructions to detect in real-time a change in content further comprises instructions to detect such changed content within a predefined velocity value.

37. The system of claim 36, wherein the predefined velocity value is measured as a point closest in time to when the content was changed, edited, or otherwise modified relative to when the content was last gathered.

38. The system of claim 35, wherein the content comprises text, audio, a link, an image, a radio broadcast, a podcast, video, a blog entry, an advertisement, a news wire, a mainstream media item, a data stream, data from a social networking website, any type of information that relates to a query, any type of information from a source, or any combination thereof.

39. The system of claim 35, wherein the processor is further configured to execute instructions stored in memory to:
receive the user's interest; and
store the user's interest in a user interest database.

40. The system of claim 35, wherein the processor is further configured to execute instructions stored in memory to tag one or more tags to the content.

41. The system of claim 39, wherein the user's interest includes a name of a person, a name of an event, a name of a publication, a topic, one or more keywords, a key phrase, a slogan, a company name, a stock ticker, a sector name, an industry name, a group name, a product name or any combination thereof.

42. The system of claim 35, wherein for the step of matching in real time the content to a user's interest, the processor is further configured to analyze the one or more tags associated with the content.

43. The system of claim 35, wherein the content comprises a document and the user's interest comprises a query having one or more query words.

44. The system of claim 43, wherein the step of matching in real time the content to a user's interest further comprises matching in real time a plurality of words in the document against the one or more query words of the query.

45. The system of claim 43, wherein the step of matching in real time the content to a user's interest further comprises:
ordering the one or more query words of the query, resulting in a query word list;
ordering the plurality of words of the document, resulting in a list of ordered words;
initializing a hash table stored in memory to empty; and
processing each word in the list of ordered words by utilizing the hash table and an inverted index, the inverted index being stored in memory.

46. The system of claim 45, wherein the query is represented by an object (i, w₁, w₂, . . . , wₙ), where i represents a number of words matched and w₁, w₂, . . . , wₙ represent the one or more query words in order and further wherein processing each word in the list of ordered words further comprises:
locating in the hash table the one or more query objects hashed with a key w;
adding one to each count of the one or more query objects;
if there is a next word on the list of ordered words, rehashing the one or more query objects according to the next word; and
if there is no next word on the list of ordered words, adding the one or more query words to a query output list matched to the document.

47. The system of claim 35, wherein for the step of determining delivery of the content, the processor is further configured to:
determine whether a match was found during the matching step;
if the match was found, transmit the content to a network-enabled device; and
if no match was found, transmit the content to an archival database.

48. The system of claim 47, wherein the network-enabled device comprises a laptop computer, a desktop computer, a smartphone, a personal digital assistant (PDA), a portable handheld device, a gaming device, a computing device, a mobile communications device, or any combination thereof.

49. The system of claim 35, wherein the processor is further configured to transmitting the content to a network-enabled device based on a user's preferences.

50. The system of claim 35, wherein the processor is further configured to:
generate an alert of the content; and
transmit for display the alert of the content to a network-enabled device in real time.

51. The system of claim 50, wherein the generated alert comprises an email, a SMS, a MMS, a ringtone, a website link, a data stream, a pop-up window, an entry on a website, an entry on a newsfeed or any combination thereof.
